(19) United States
(12) Patent Application Publication
(10) Pub. No.: US 2024/0141945 A1
(43) Pub. Date: May 2, 2024

(54) FASTENER HAVING A SPECIFIC RING STRUCTURE SUPPORTING HIGHER LOAD VALUE

(71) Applicant: AJ2 Steel Inc, Brentwood, CA (US)

(72) Inventors: Amador Fajardo, Union City, CA (US); ADAM RUBIO, BRENTWOOD, CA (US)

(73) Assignee: AJ2 Steel Inc, BRENTWOOD, CA (US)

(21) Appl. No.: 18/383,036

(22) Filed: Oct. 23, 2023

Related U.S. Application Data
(60) Provisional application No. 63/421,128, filed on Oct. 31, 2022.

(51) Int. Cl. F16B 35/04

(52) U.S. Cl. CPC F16B 35/041

(57) ABSTRACT

A fastener includes a head, shank and a point of specific length, shape and parts. The shank has two parts, a smooth shank and deformed shank. There is a specific ratio for length between the smooth shank and deformed shank. The deformed shank is ringed. A specific thickness, specific material and specific dimension and design of head, shank and point is designed to have superior load and withdrawal strengths. The diameter of the fasteners are 0.115, 0.125, and 0.135. The fasteners are offered as single unit or multiple units for use.

### CROSS REFERENCE TO RELATED APPLICATION

This application claims priority to U.S. Provisional application 63/421,128 filed on Oct. 31^{st} 2022. The contents of the said application is incorporated in its entirety herein by reference.

### FIELD OF THE INVENTION

A fastener with specific ring structure and diameter to hold and bear a higher load value is described.

### BACKGROUND

Fasteners have been used in the construction industry for a long time. Specific fasteners must be used by end users, builders, framers and contactors for a specific application. There is always a lot inventory that needs to be carried and different choices that need to be offered with existing nails/fasteners. Many require specific tools for use, and due to so many varieties sometimes incorrect nails are used by the user. This may lead to not meeting the Structural Engineer design load. Using benchmark nails may lead to wood splitting, nails pops, and confusion. This also results in higher prices as so many have to be kept in inventory. There needs to be solutions to reduce inventory, nail confusion and have a higher quality nail that could be used for most applications.

### SUMMARY

Several embodiments of the instant invention a fastener (nail) is described. In one embodiment a fastener with a ring structure at the bottom of the elongated shaft of the fastener is described. In one embodiment, the fastener is used for securing wooden structures, sheath materials and generally used for construction of a dwelling or furniture's or any soft material that needs to be joined to make an article or structure.

The fastener, in one embodiment has a head, shank and a point. In another embodiment, the shank is divided into a smooth shank and a deformed shank. In another embodiment, the ratio between smooth shank and the deformed shank is specific. In one embodiment, the head has a specific thickness. A specific thickness, specific material and specific dimension and design of head, shank and point is designed to have superior load and withdrawal strengths. In one embodiment, bending yield strength tests, ductility tests, lateral load connection tests and withdrawal load tests on the instant proprietary 2⅛″×0.115R, 2¾″×0.115R, 3″×0.115R, 3″×0.115 and 3″×0.135R, 3″×0.135, 2¼″×0.125R, 3″×0.125R and 3″×0.125 ring shank nails.

In one embodiment and not limited to these values, the instant fastener has the following properties:
Smaller shank diameter with higher lateral and withdrawal load.
0.115 nail has 124 lbs of lateral and 68 lbs/in for withdrawal.
0.115R nail has 106 lbs of lateral and 82 lbs/in for withdrawal.
0.125 nail has 131 lbs of lateral and 66 lbs/in for withdrawal.
0.125R nail has 122 lbs of lateral and 77 lbs/in for withdrawal.
0.135 nail has 149 lbs of lateral and 62 lbs/in for withdrawal.
0.135R nail has 145 lbs of lateral and 71 lbs/in for withdrawal.

In one embodiment, Ductility Test, Bending Yield Strength Test, Pull through Test, Lateral Strength Test, Withdrawal Strength Test, Low Seismic Wall Assembly Test, In-Plane Cyclic Load Test and Small Scale Diaphragm Test were conducted on all three diameter nails to meet the ASTM standards, AC116, AC120 and beat the control benchmark nails (8 d common 2½″×0.131, 10 d common 3″×0.148 and 16 d common 3½″×0.162) quality.

In another embodiment, the point has a specific shape and a specific angle for optimal entry and exit from a material in which it is used for fastening. The fastener is manufacture using specific material and in one example it is steel. Accordingly, the specification and drawings are to be regarded in an illustrative rather than a restrictive sense.

### BRIEF DESCRIPTION OF DRAWINGS

Example embodiments are illustrated by way of example and not limitation in the figures of the accompanying drawings, in which like references indicate similar elements and in which:

FIGS. 1A, 1B, 1C and 1D shows fasteners type one, in one embodiment.

FIGS. 2A, 2B, 2C, and 2D shows fasteners type two, in one embodiment.

FIGS. 3A, 3B, 3C and 3D shows fasteners type three, in one embodiment.

FIG. 4 shows collated fasteners for all types of fasteners.

Other features of the present embodiments will be apparent from the accompanying drawings and from the detailed description that follows.

### DETAILED DESCRIPTION

Several fasteners with various heads, shanks and point are described as a possible variation including coating which are coarse thread, construction thread, drywall ‘fine’ thread, availability in stainless steel or common steel, availability in coatings to resist rust (zinc) or made of alloys to prevent rust used in exposed outside work, painted or plated screws and nails but not limited to these specifically. In a broader spirit there are different types of heads that may be implemented. For example, heads that sit above the surface, such as pan head, oval head, round head, hex head and others. In another embodiment, flat heads with beveled sides leading down to the shank. The flat head fastener gives a flushed appearance. In a general use flat head fastener is used within framing, boxing, crates, pallets, fencing, and general timber fixing applications. Although the present embodiments have been described with reference to specific example embodiments, it will be evident that various modifications and changes may be made to these embodiments without departing from the broader spirit and scope of the various embodiments. The term “fastener” is used interchangeably as “nail” or fastener” through the specification.

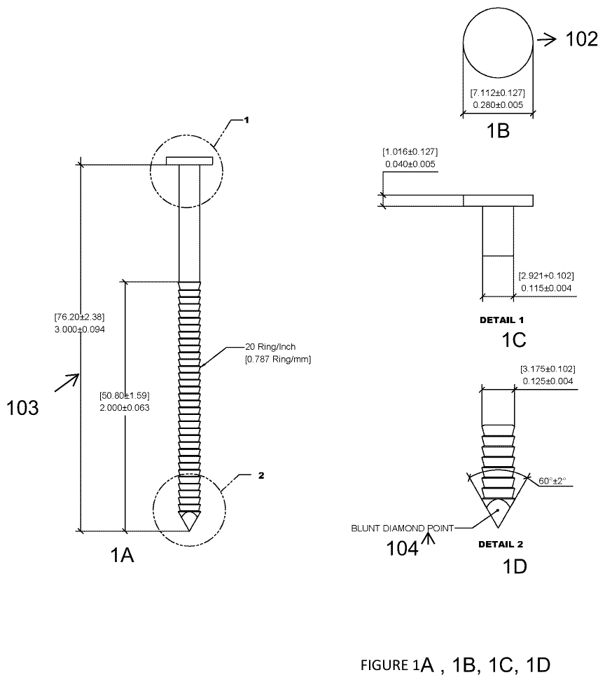

FIGS. 1A, 1B, 1C and 1D shows fastener 0.115 as an example. The head (FIG. 1B) 102 diameter is between 7-7.3. More specifically it is 7.12±0.127, the depth of the head is 1.016±0.127. A shank 103 (in FIG. 1A) has two parts, a smooth shank and a deformed shank. The smooth shank diameter is 2.921±0.102 (FIG. 1C), the crest diameter for the deformed shank at the start is 3.175±0.102 and the blunt diamond point 104 has an angle of 60°±2° (FIG. 1D). In one embodiment, there can be 18-22 rings per inch, more specifically 20 rings per inch in the deformed shank. The entire shank to tip length from the bottom of the head is 76.20±2.38 mm in length. These dimensions are before plating the fasteners. The head surface may have continuous convex radial shape. The ratio between smooth shank and deformed shank area in a fastener is between 20/80 percent. The smooth shank area is 20 percent of the entire length of the shank and the deformed shank is 80 percent entire length of the shank.

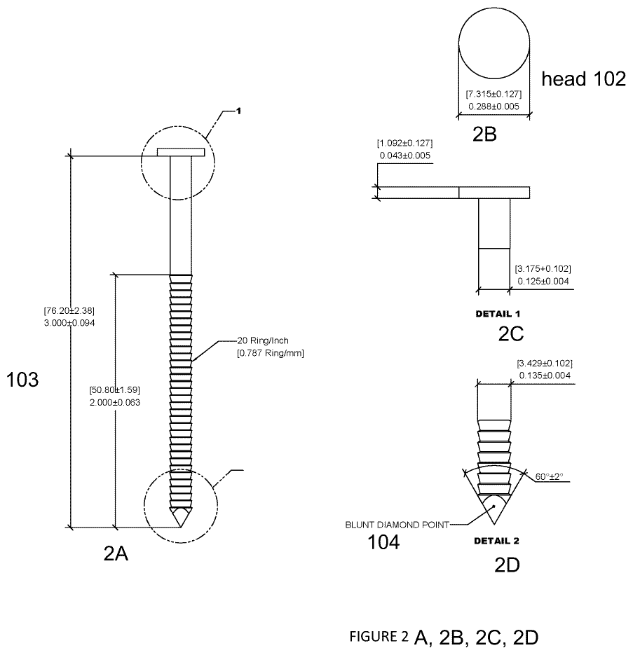

FIGS. 2A, 2B, 2C, and 2D shows fastener 0.125 as an example. The head (102) diameter is between 7.28-7.4 (FIG. 2B). More specifically it is 7.315±0.127, the depth of the head is 1.092±0.127, smooth shank diameter is 3.175±0.102, the crest diameter for the deformed shank at the start is 3.3.429±0.102 and the blunt diamond point has an angle of 60°+2°. In one embodiment, there can be 18-22 rings per inch, more specifically 20 rings per inch in the deformed shank. The entire shank (103) to tip length from the bottom of the head is 76.20±2.38 mm in length (FIG. 1A). These dimensions are before plating the fastener. The head surface may have continuous convex radial shape. The ratio between smooth shank and deformed shank area in a fastener is between 20/80 percent. The smooth shank area is 20 percent of the entire length of the shank and the deformed shank is 80 percent entire length of the shank.

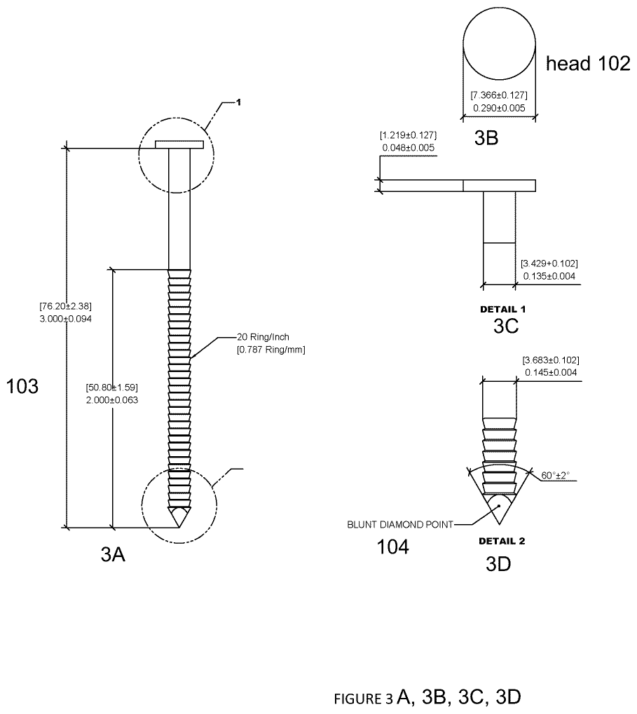

FIGS. 3A, 3B, 3C and 3D shows fastener 0.135 as an example. The head (102) diameter is between 7.3-7.4 (FIG. 3B). More specifically it is 7.366±0.127, the depth of the head is 1.219±0.127, smooth shank (FIG. 3C) diameter is 3.429±0.102, the crest diameter for the deformed shank at the start is 3.683±0.102 and the blunt diamond point has an angle of 60°±2° (FIG. 3C). In one embodiment, there can be 18-22 rings per inch, more specifically 20 rings per inch in the deformed shank. The entire shank 103 to tip length from the bottom of the head is 76.20±2.38 mm in length (FIG. 3A). These dimensions are before plating the fastener. The head surface may have continuous convex radial shape. The ratio between smooth shank and deformed shank area in a fastener is between 20/80 percent. The smooth shank area is 20 percent of the entire length of the shank and the deformed shank is 80 percent entire length of the shank.

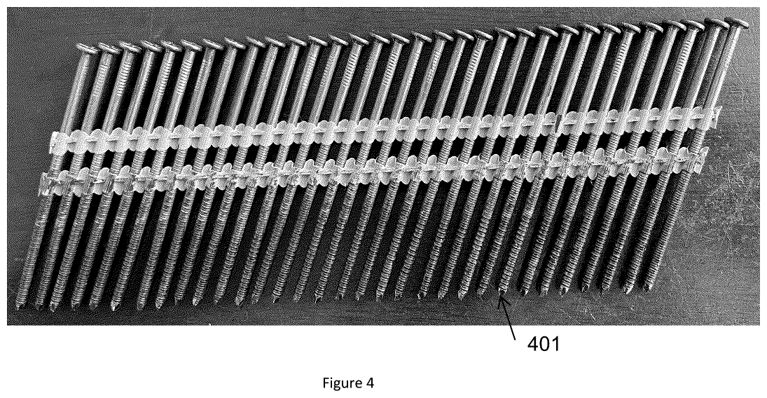

FIG. 4 shows fasteners in a row (401). This is a unique offering as these kind of framing nails are useful with bulk supply and continuous supply for nail guns. The fasteners is made up of carbon steel and the grade is between C1020 and C1050. More specifically the steel used for 0.115, 0.125 and 0.135 the grade of carbon steel is C1038 and for 0.115R, 0.125R and 0.1135R the grade is C1026. The nail diameter is between 0.111-0.139 inch. More specifically the NDS load is between 97-150 lbs. In one embodiment, the nail head may be altered depending on the function and can be flat head, checkered flat head with a grid pattern, countersunk or cupped heads. The instant nails are primarily used for framing. But in one embodiment, they can be used not only between wood to wood, but can be used when glues are used to join two surfaces such as steel to wood, tile to wood, concrete to wood and masonry to wood etc.

Several tests were conducted and compared to standard 8 d common, 10 d common and 16 d common benchmark nails to not only qualify but show that instantly claimed fastener (nail) is superior to all standard nails available in the market. The list of tests that were conducted were:

Ductility Test—The only certain way to create a ductile timber structure is by using a design in which collapse is governed by failures in mechanical dowel-type joints where nails are the most ductile connectors. Ductility in itself is characterized as deformation capacity and is defined in this paper as the ability of a connection to deform and redistribute forces. The definitions of ductility are all expressed as the relationship between three key deformations: u_{y} defined as the elastic displacement, uᵤ as the displacement at maximum load and u_{f} as the displacement at fracture (ultimate displacement).

Bending Yield Strength Test—Engineering design procedures used to determine the capacities of laterally-loaded nailed connections currently use a yield theory to establish the nominal resistance for laterally-loaded nailed connections that are engineered. In order to develop the nominal resistance for laterally-loaded nailed connections, the bending yield moment must be known.

Pull through Test—A standard ASTM nail head pull-through test has been used to determine the resistance of a wood material by pulling the head of a nail through the thickness of the specimen.

Lateral Strength Test—Lateral strength is largely a function of a nail's diameter and the density of the type of wood into which the nail is driven. For example, 10 d and 12 d nails have the same diameter and the same lateral strength in each type of wood.

Withdrawal Strength Test, Low Seismic Wall Assembly Test, In-Plane Cyclic Load Test and Small Scale Diaphragm Test—When these buildings are constructed in seismically active zones, seismic design and construction methods become crucial. Wood shear walls are the primary lateral load resisting system for this type of buildings. They are composed of studs, sheathing panels, and nail connections. The in-plane lateral load resistant capacity is mainly provided by the sheathing panels through the sheathing-to-frame connections. Nail joints primarily contribute to energy dissipation while withstanding earthquake.

The nails are tested for ASTM standards, bending yield strength, lateral connection strength, withdrawal strength, and use in diaphragms and shear walls, use as alternatives to the nails prescribed in fastening schedules in the codes as well. The length of the nail can be from 1″ thru 12″ long. The fasteners were tested for bending yield strength test, ductility test, lateral load connection test and withdrawal load test on 5000 pieces of 0.115R, 0.115, 0.125R, 0.125, 0.135R and 0.135 fasteners. The length of 0.115R is 2⅛″, 2¾″ and 3″. The length of 0.115 is 3″. The length of 0.125R is 2¼″ and 3″. The length of 0.125 is 3″. The length of 0.135R and 0.135 is 3″.

The test program was conducted pursuant to ICC-ES AC116 Acceptance Criteria for Nails, approved March 2018 and editorially revised February 2021, ASTM F1575-2021 Standard. Method for Determining Bending Yield Moment of Nails, ASTM F1667-2021a Standard Specification for Driven Fasteners: Nails, Spikes, and Staples, ASTM D1761-20 Standard Test Methods for Mechanical Fasteners in Wood and Wood-Based Materials, ASTM D2395-17 (2022). Standard Test Methods for Density and Specific Gravity (Relative Density) of Wood and Wood-Based Materials and ASTM D4442-20 Standard Test Methods for Direct Moisture Content. Measurement of Wood and Wood-Based Materials. Specialized Testing, Inc. (STI), dba Specialized Testing, was the laboratory of record for this project. Specialized Testing's is accredited under ISO 17025 by the International Accreditation. Service (IAS) as listed on IAS TL-228, which lists AC116. All tests reported herein were performed at the laboratory facilities of Specialized Testing located in Santa Fe Springs, CA.

Bending yield strength and ductility for the instant proprietary 3″×0.115R, 3″×0.125R, 3″×0.125, 3″×0.135 and 3″×0.135R nails, lateral load connection strength for the instant 2¾″×0.115R, 3″×0.115R, 3″×0.125R, 3″×0.125, 3″×0.135 and 3″×0.135R nails, and withdrawal connection strength of the instant 3″×0.115R, 3″×0.125R, 3″×0.125, 3″×0.135 and 3″×0.135R nail. For comparison, lateral and withdrawal tests were also performed using 8 d 3″×0.131, 10 d common 3″×0.148 and 16 d common 3½″×0.162 benchmark nails. Lateral strength connection tests were performed with Douglas Fir nominal 2×(1½″ thick) lumber, with either nominal 4×(3½″ thick) Douglas Fir main members or 3½″ thick Engineered Wood Product (EWP) as the main member. Withdrawal tests were performed with either Douglas Fir nominal 4×(3½″ thick) and 3½″ thick EWP wood. All wood was acquired by, selected and prepared by the client. The wood was confirmed and tested by STI. The tested nails were installed into the wood by STI technicians. The bending strength tests were performed on a United Universal Test Machine (UTM) in accordance with ASTM F1575. Ductility tests were performed by hand without measurement. Connection strength tests in wood were performed using the United UTM. All forces and displacement measurements together with dimension measurements were made with equipment having calibrations traceable to NIST. Connection tests of the nails were performed in Douglas Fir Wood having a nominal specific gravity of 0.50. Douglas Fir lumber in nominal thicknesses of 2× and 4× and Timberstrand® LSL. The specific gravity of the Douglas Fir lumber was tested in accordance with ASTM D2395 and the results of those tests are presented in table below. The bending strength of the instant fasteners and reference common nails exceed the minimum requirement.

TABLE 1
Summary of Bending Yield Moment Data:

| Nominal | Nominal | | | | | |
|---|---|---|---|---|---|---|
| Diameter | Length | F_{yb, mean} | | | F_{yb, min} | Fₜₑₛₜ > |
| (in.) | (in.) | (psi) | COV | nₜₑₛₜ | (psi) | F_{spec} |
| 0.115 | 3 | 140,000 | 0.029 | 15 | 100,000 | yes |
| 0.115 R | 3 | 133,000 | 0.031 | 15 | 100,000 | yes |
| 0.125 | 3 | 152,000 | 0.038 | 15 | 100,000 | yes |
| 0.125 R | 3 | 122,000 | 0.038 | 15 | 100,000 | yes |
| 0.135 | 3 | 130,000 | 0.029 | 15 | 100,000 | yes |
| 0.135 R | 3 | 113,000 | 0.037 | 15 | 100,000 | yes |

Notes to Table 1:
a. F_{yb, mean} is average bending strength of fifteen replicates (rounded to nearest 1,000 psi.
b. COV is the coefficient of variation of the F_{yb} results
c. nₜₑₛₜ denotes the number of test replicates in the data set
d. F_{yb, min} taken from Table 1 of AC116

TABLE 2
Results of Ductility Tests on instant fasteners:

| | Nominal | Pass Ductility Test | | | | | | |
|---|---|---|---|---|---|---|---|---|
| Nominal | Length | Test Specimen | | | | | | |
| Diameter | (in) | 1 | 2 | 3 | 4 | 5 | 6 | 7 |
| 0.115 | 3 | Pass | Pass | Pass | Pass | Pass | Pass | Pass |
| 0.115 R | 3 | Pass | Pass | Pass | Pass | Pass | Pass | Pass |
| 0.125 | 3 | Pass | Pass | Pass | Pass | Pass | Pass | Pass |
| 0.125 R | 3 | Pass | Pass | Pass | Pass | Pass | Pass | Pass |
| 0.135 | 3 | Pass | Pass | Pass | Pass | Pass | Pass | Pass |
| 0.135 R | 3 | Pass | Pass | Pass | Pass | Pass | Pass | Pass |

Note: Pass denotes successful 180° Bend of Nail without evidence of fracture.

Each fastener goes through rigorous testing protocols and edge imperfections up to 0.005 wide×0.010 deep are acceptable, but laps, seams, cracks or similar defects greater than 0.005×0.010 are not acceptable. No visible rust is acceptable. Contamination of fasteners with dust, oil, wire draw lube etc., cannot exceed 0.0026.

TABLE 3
Summary of Wood Connection Lateral Load Tests:

| Nominal | Nominal | Main | Side | | Mean | | | | | | | |
|---|---|---|---|---|---|---|---|---|---|---|---|---|
| Diameter | Length | Member | Member | Mean | M.C. | F_{max, ave} | σ | | | | | |
| (in.) | in. | (in.) | (in.) | S.G. | (%) | (lbf) | (lbf) | COV | nₜₑₛₜ | df_{CI=0.75} | t | n_{req'd} |
| 0.115 R | 2¾ | 3½ | 1½ | 0.50 | 11.3 | 541 | 106 | 0.189 | 21 | 20 | 1.185 | 20 |
| | | DF | | | | | | | | | | |
| 0.115 R | 3 | 2½ | 1½ | 0.49 | 12.0 | 531 | 137 | 0.128 | 15 | 14 | 1.200 | 9 |
| | | DF | | | | | | | | | | |
| 0.131 | 3 | 2½ | 1½ | 0.48 | 10.8 | 387 | 41 | 0.106 | 15 | 14 | 1.200 | 7 |
| | | DF | | | | | | | | | | |
| 0.115 | 3 | 2½ | 1½ | 0.51 | 12.9 | 618 | 93 | 0.150 | 15 | 14 | 1.200 | 13 |
| | | DF | | | | | | | | | | |
| 0.125 R | 3 | 2½ | 1½ | 0.48 | 12.3 | 608 | 133 | 0.174 | 17 | 16 | 1.194 | 17 |
| | | DF | | | | | | | | | | |
| 0.125 | 3 | 2½ | 1½ | 0.51 | 12.5 | 657 | 76 | 0.115 | 15 | 14 | 1.200 | 8 |
| | | DF | | | | | | | | | | |
| 0.148 | 3 | 2½ | 1½ | 0.48 | 11.0 | 486 | 48 | 0.098 | 15 | 14 | 1.200 | 6 |
| | | DF | | | | | | | | | | |
| 0.135 | 3 | 2½ | 1½ | 0.50 | 13.8 | 744 | 97 | 0.131 | 15 | 14 | 1.200 | 10 |
| | | DF | | | | | | | | | | |
| 0.135 R | 3 | 3½ | 1½ | 0.50 | 10.7 | 724 | 107 | 0.171 | 17 | 16 | 1.194 | 17 |
| | | DF | | | | | | | | | | |
| 0.135 R | 3 | 3½ | 1½ | 0.48 | 10.6 | 726 | 110 | 0.104 | 15 | 14 | 1.200 | 6 |
| | | EWP | | | | | | | | | | |
| 0.162 | 3½ | 3½ | 1½ | 0.49 | 10.6 | 448 | 108 | 0.134 | 15 | 14 | 1.200 | 10 |
| | | EWP | | | | | | | | | | |

Notes to Table 3:
a. For all tests, the side member were 1½″ thick and the main member 3½″ thick.
b. The mean specific gravity and mean M.C. are the average specific gravity and measured moisture content of all wood members used in the test series. For tests into EWP, M.C. is only for the side members.
c. F_{max, ave} is the average of all the ultimate loads recorded for the test series.
d. σ is the standard deviation of the set of ultimate loads.
e. COV is the coefficient of variation (standard deviation/average) of the set of ultimate loads.
f. nₜₑₛₜ is the number of test replicates in each data set.
g. df_{CI=0.7} is the degrees of freedom of each data set, whereby df = nₜₑₛₜ − 1.
h. t is the statistic for calculating samples size based on confidence interval, CI, of 75% (reference AC116 Section 4.1.2 and ASTM D2915 Table 1).
i. n_{req'd} is the required sample size based on the data and ASTM D2915 Equation 1: n_{req'd} = ((t/0.05) · COV)²: n_{req'd} test.

For each of the eleven data sets listed in Table 3, the number of test replicates equaled or exceeded the value required number of replicates based on the provisions of Section 4.1.2 of AC116 together with ASTM D2915. Therefore, the requirements of Section 4.1.2 of AC116 are satisfied with respect to the confidence of the data set.

TABLE 4
Summary of Wood Connection Withdrawal Load Tests:

| Nominal | Nominal | Main | | Mean | | | | | | | |
|---|---|---|---|---|---|---|---|---|---|---|---|
| Diameter | Length | Member | Mean | M.C. | F_{max, ave} | σ | | | | | |
| (in.) | (in.) | (in.) | S.G. | (%) | (lbf) | (lbf) | COV | nₜₑₛₜ | df_{CI=0.75} | t | n_{req'd} |
| 0.115 R | 3 | 3½ | 0.48 | 11.9 | 716 | 163 | 0.103 | 15 | 14 | 1.20 | 6 |
| | | DF | | | | | | | | | |
| 0.131 | 3 | 3½ | 0.48 | 9.8 | 319 | 29 | 0.092 | 15 | 14 | 1.20 | 5 |
| | | DF | | | | | | | | | |
| 0.115 | 3 | 3½ | 0.51 | 11.9 | 596 | 88 | 0.148 | 15 | 14 | 1.20 | 13 |
| | | DF | | | | | | | | | |
| 0.125 R | 3 | 3½ | 0.48 | 12.2 | 678 | 134 | 0.125 | 15 | 14 | 1.20 | 9 |
| | | DF | | | | | | | | | |
| 0.125 | 3 | 3½ | 0.49 | 12.3 | 580 | 64 | 0.110 | 15 | 14 | 1.20 | 7 |
| | | DF | | | | | | | | | |
| 0.148 | 3 | 3½ | 0.49 | 12.1 | 256 | 52 | 0.204 | 15 | 14 | 1.20 | 24 |
| | | DF | | | | | | | | | |
| 0.135 | 3 | 3½ | 0.48 | 12.2 | 541 | 67 | 0.124 | 15 | 14 | 1.20 | 9 |
| | | DF | | | | | | | | | |
| 0.135 R | 3 | 3½ | 0.51 | 10.9 | 621 | 40 | 0.064 | 15 | 14 | 1.200 | 2 |
| | | DF | | | | | | | | | |
| 0.135 R | 3 | 3½ | n/a | n/a | 925 | 77 | 0.083 | 15 | 14 | 1.200 | 4 |
| | | EWP | | | | | | | | | |
| 0.162 | 3½ | 3½ | n/a | n/a | 336 | 77 | 0.183 | 19 | 18 | 1.189 | 19 |
| | | EWP | | | | | | | | | |

Notes to Table 4:
a. For all tests, the wood member was a nominal 4X (3½″ thick) and the nail penetrated 1¾″ into the wood member.
b. The mean specific gravity and mean M.C. are the average specific gravity and measured moisture content of all wood members used in the test series. For tests into EWP, M.C. is only for the side members.
c. F_{max, ave} is the average of all the ultimate loads recorded for the test series.
d. σ is the standard deviation of the set of ultimate loads.
e. COV is the coefficient of variation (standard deviation/average) of the set of ultimate loads.
f. nₜₑₛₜ is the number of test replicates in each data set.
g. df_{CI=0.7} is the degrees of freedom of each data set, whereby df = nₜₑₛₜ − 1.
h. t is the statistic for calculating samples size based on confidence interval, CI, of 75% (reference AC116 Section 4.1.2 and ASTM D2915 Table 1).
i. n_{req'd} is the required sample size based on the data and ASTM D2915 Equation 1: n_{req'd} = ((t/0.05) · COV)²: n_{req'd} test.

For the data sets listed in Table 4, the number of test replicates equaled or exceeded the value required number of replicates based on the provisions of Section 4.1.2 of AC116 together with ASTM D2915. Therefore, the requirements of Section 4.1.2 of AC116 are satisfied with respect confidence of the data set.

All eleven examples are tested for their lateral and withdrawal strengths. All show superior and unexpected results compared to regular nails. The superior results may be attributed to shank design, small shank diameter, ring ratio and steel used for the said fastener. The four designs are very specific for their length, crest diameter, length of the deformed shank and for their relative ration between smooth shank and deformed shank. The ring shank also provides a certain physical strength by having a specific spacing, crest diameter and a specific angle of the point. The specific design of the fastener enables superior lateral load and withdrawal load. These ultimately gives a superior hold for a specific use.

TABLE 5
Comparison in NDS values between common
nails and instant claimed fasteners.
COMPARISON IN NDS VALUES

| Nominal | Lateral | Withdrawal |
|---|---|---|
| Diameter | Load Z | Load W |
| (in.) | (lbf) | (lbf/in) |
| 0.115 R | 106 | 82 |
| 8d common | 97 | 32 |
| 0.115 | 124 | 68 |
| 0.125 R | 122 | 77 |
| 0.125 | 131 | 66 |
| 10d common | 118 | 36 |
| 0.135 R | 145 | 71 |
| 0.135 | 149 | 62 |
| 16d common | 141 | 40 |

TABLE 6
Withdrawal test in Douglas Fir Wood:

| Nominal | Nominal | Main | Side | |
|---|---|---|---|---|
| Diameter | Length | Member | Member | Fmax.ave |
| (in.) | (in.) | (in.) | (in.) | (lbf) |
| 0.115 R | 3 | 2½ | 1½ | 716 |
| 8d common | 3 | 2½ | 1½ | 319 |
| 0.115 | 3 | 2½ | 1½ | 596 |
| 0.125 R | 3 | 2½ | 1½ | 678 |
| 0.125 | 3 | 2½ | 1½ | 580 |
| 10d common | 3 | 2½ | 1½ | 256 |
| 0.135 R | 3 | 3½ | 1½ | 621 |
| 0.135 | 3 | 2½ | 1½ | 541 |
| 16d common | 3⅓ | 2½ | 1½ | 387 |

TABLE 7
Lateral load test in Douglas Fir Wood:

| Nominal | Nominal | Main | Side | |
|---|---|---|---|---|
| Diameter | Length | Member | Member | Fmax.ave |
| (in.) | (in.) | (in.) | (in.) | (lbf) |
| 0.115 R | 2¾ | 3½ | 1½ | 541 |
| 0.115 R | 3 | 2½ | 1½ | 531 |
| 8d common | 3 | 2½ | 1½ | 387 |
| 0.115 | 3 | 2½ | 1½ | 618 |
| 0.125 R | 3 | 2½ | 1½ | 608 |
| 0.125 | 3 | 2½ | 1½ | 657 |
| 10d common | 3 | 2½ | 1½ | 486 |
| 0.135 R | 3 | 3½ | 1½ | 724 |
| 0.135 | 3 | 2½ | 1½ | 744 |
| 16d common | 3⅓ | 2½ | 1½ | 647 |

TABLE 8
Lateral load test in Engineered Wood Product:

| Nominal | Nominal | Main | Side | |
|---|---|---|---|---|
| Diameter | Length | Member | Member | Fmax.ave |
| (in.) | (in.) | (in.) | (in.) | (lbf) |
| 0.135 R | 3 | 3½ | 1½ | 925 |
| 16d common | 3½ | 2½ | 1½ | 336 |

The objective of the test program was to conduct small-scale diaphragm simulation tests in accordance with ICC Evaluation Service, LLC (ICC-Es) AC 120 Acceptance criteria for wood-frame horizontal diaphragms, vertical shear walls and braced walls with alternative fasteners, approved February 2017 and editorially revised January 2021 for AJ2 Steel Inc. The tests were performed primarily in accordance with Section 4.9 of AC120 on small scale wood diaphragms fabricated to match the set up depicted in FIG. 9 of AC 120. The tests were performed with AJ2 Steel proprietary nails 2⅛″×*0.115R and 2¼ 0.125 R nails and benchmark 8 d common and 10 d common nails. The test were carried out in accordance with the test plan prepared by the client. The test program was conducted pursuant to ICC-ES AC 120 and also ASTM D2395-17 (2022) standard test methods for Density and Specific gravity (Relative Density) of wood and wood based material and ASTM D4442-20 Standard test methods for direct moisture content measurement of wood and wood based materials. All tests reported herein were performed at the laboratory facilities of Specialized Testing located in Santa Fe Springs, CA.

TABLE 9
Diaphragm Comparison of Proprietary
instant nails vs Benchmark nails

| | Tests with Instant nails | | | Tests with Benchmark nails | | |
|---|---|---|---|---|---|---|
| | | | Peak | | | Peak |
| Sheeting | | Peak | load | | Peak | load |
| thickness | | load | Defl. | | load | Defl. |
| (in) | Set | (lbf) | (in.) | Set | (lbf) | (in.) |
| ⅜″ OSB | 0.115 R | 3914 | 0.431 | 8d | 2943 | 0.306 |
| 15/32″ OSB | 0.115 R | 4521 | 0.488 | 8d | 3404 | 0.347 |
| 15/32″ OSB | 0.125 R | 5150 | 0.464 | 10d | 3648 | 0.387 |
| 23/32″ OSB | 0.125 R | 5742 | 0.513 | 10d | 4332 | 0.466 |
| 23/32″ OSB | 0.115 R | 5491 | 0.562 | 10d | 4332 | 0.466 |

TABLE 10
Shear Wall Comparison of Proprietary
instant nails vs Benchmark nails

| | Test with Instant Nails | | | | |
|---|---|---|---|---|---|
| | | | Peak | NDS with Benchmark Nails | |
| Sheathing | | Peak | Load | | Peak |
| Thickness | | Load | Deflection | | Load |
| (in.) | Set | (plf) | (in.) | Set | (plf) |
| ⅜ OSB | 2⅛″ × | 816 | 2.039 | 8d common | 220 |
| | 0.115 R | | | | |
| ⅜ OSB | 2¼″ × | 892 | 2.235 | 10d common | n/a |
| | 0.125 R | | | | |
| 15/32 OSB | 2⅛″ × | 790 | 2.026 | 8d common | 640 |
| | 0.115 R | | | | |
| 15/32 OSB | 2⅛″ × | 790 | 2.026 | 10d common | 770 |
| | 0.115 R | | | | |
| 19/32 OSB | 2⅛″ × | 1025 | 2.463 | 10d common | 870 |
| | 0.115 R | | | | |
| 19/32 OSB | 2¼″ × | 975 | 2.976 | 10d common | 870 |
| | 0.125 R | | | | |

All replicates failed the same way and were all within the standards of rules by the federal government requirements for seismic activity. This illustrates that the instantly claimed nails exceed the qualities in certain criteria's and in certain instances they comply with all the construction related rules as superior products compared to what is available in the market.

### INDUSTRIAL APPLICABILITY

The instant fasteners of diameter 0.115, 0.115R, 0.125, 0.125R, 0.135 and 0.135R exceeds or beats all tests that are relevant to ASTM standards compared to what is available in the market. The unique design of combination of deformed shank and smooth shank is much superior to what is available in the construction industry. Various diameter options with unique design and collated nail capability allows the user to use the product in high volume construction zones with ease.

What we claim is:

1. A fastener, comprising:
a head, wherein the head is flat;
a shank that has two parts, a smooth shank and a deformed shank;
a point, wherein the point is a blunt diamond point, and
the fastener has gone through a specific test to meet and beat a standard requirement compared to a control sample.

2. The fastener of claim 1, wherein the smooth shank length is 30%-35% and the deformed shank is 70%-65% of the entire length of the fastener.

3. The fastener of claim 1, wherein the specific test is at least one of lateral load test, ductility test, bending yield strength test, pull through test, withdrawal strength test, low seismic wall assembly test, in-plane cyclic load test and small scale diaphragm test.

4. The fastener of claim 1, wherein the said fastener diameter is at least one of 0.135, 0.135R, 0.115, 0.115R, 0.125 and 0.125R.

5. The fastener of claim 4, wherein the said fastener is compared with standard nail diameter of 0.162, 0.131 and 0.148 common nails.

6. The fastener of claim 1, wherein the fastener is a single fastener or multiple fastener.

7. The fastener of claim 1 is made up of carbon steel with a grade between C1020-C1050.

8. A fastener, comprising of:
a head, wherein the head is flat;
a shank that has two parts, a smooth shank and a deformed shank;
a point, wherein the point is a blunt diamond point, and
the fastener has gone through a specific test to meet and beat a standard requirement compared to a control sample, wherein the diameter of the fastener is at least one of a 0.135R, 0.115R and 0.125R.

9. The fastener of claim 8, wherein the specific test for 0.135R is a lateral load test in Douglas fir wood, wherein the said fastener has an fmax.ave of 724 compared to the control sample 16 d common nail has an fmax.ave of 647, wherein the specific test is a lateral load test in engineered wood product, wherein the said fastener has an fmax.ave of 726 compared to the control sample 16 d common nail has an fmax.ave of 448, wherein the specific test is a withdrawal test in Douglas fir wood, wherein the said fastener has an fmax.ave of 621 compared to the control sample 16 d common nail has an fmax.ave of 387, wherein the specific test is a withdrawal test in Douglas fir wood in engineered wood product, wherein the said fastener has an fmax.ave of 925 compared to the control sample 16 d common nail has an fmax.ave of 336.

10. The fastener of claim 8, wherein the specific test for 0.125R is a withdrawal test in Douglas fir wood, wherein the said fastener has an fmax.ave of 678 compared to the control sample 10 d common nail of has an fmax.ave of 256, wherein the specific test is a lateral load test in Douglas fir wood, wherein the said fastener has an fmax.ave of 608 compared to the control sample 10 d common nail has an fmax.ave of 486.

11. The fastener of claim 8, wherein the specific test for 0.115R is a withdrawal test in Douglas fir wood, wherein the said fastener has an fmax.ave of 531 compared to the control sample 8 d common nail has an fmax.ave of 387, wherein the specific test is a lateral load test in Douglas fir wood, wherein the said fastener has an fmax.ave of 531 compared to the control sample 8 d common nail has an fmax.ave of 387.

12. The fastener of claim 8, wherein the fastener is a single fastener or multiple fastener.

13. The fastener of claim 8 is made up of carbon steel with a grade between C1020-C1050.

14. A fastener, comprising of:
a head, wherein the is flat;
a shank that has two parts, a smooth shank and a deformed shank;
a point, wherein the point is a blunt diamond point, and
the fastener has gone through a specific test to meet and beat a standard requirement compared to a control sample, wherein the diameter of the fastener is 0.115, 0.125 and 0.135.

15. The fastener of claim 14, wherein the diameter of the fastener is 0.135, wherein the specific test is a withdrawal test in Douglas fir wood, wherein the said fastener has an fmax.ave of 541 compared to the control sample 16 d common nail has an fmax.ave of 387, wherein the specific test is a lateral load test in Douglas fir wood, wherein the said fastener has an fmax.ave of 744 compared to the control sample 16 d common nail has an fmax.ave of 647.

16. The fastener of claim 14, wherein the fastener is a single fastener or multiple fastener.

17. The fastener of claim 14, wherein the diameter of the fastener is 0.125, wherein the specific test is a withdrawal test in Douglas fir wood, wherein the said fastener has an fmax.ave of 580 compared to the control sample 10 d common nail has an fmax.ave of 256, wherein the specific test is a lateral load test in Douglas fir wood, wherein the said fastener has an fmax.ave of 657 compared to the control sample 10 d common nail has an fmax.ave of 486.

18. The fastener of claim 14, wherein the diameter of the fastener is 0.115, wherein the specific test is a withdrawal test in Douglas fir wood, wherein the said fastener has an fmax.ave of 596 compared to the control sample 10 d common nail has an fmax.ave of 256, wherein the specific test is a lateral load test in Douglas fir wood, wherein the said fastener has an fmax.ave of 531 compared to the control sample 10 d common nail has an fmax.ave of 486.

19. The fastener of claim 14 is made up of carbon steel with a grade between C1020-C1050.
